(19) United States
(12) Patent Application Publication
(10) Pub. No.: US 2025/0078804 A1
(43) Pub. Date: Mar. 6, 2025

(54) NOISE CONTROL APPARATUS, NOISE CONTROL SYSTEM, NOISE CONTROL METHOD, AND PROGRAM

(71) Applicant: NIPPON TELEGRAPH AND TELEPHONE CORPORATION, Tokyo (JP)

(72) Inventors: Shihori KOZUKA, Tokyo (JP); Noriyoshi KAMADO, Tokyo (JP); Hiroaki ITO, Tokyo (JP); Yohei WAKISAKA, Tokyo (JP); Shin MURATA, Tokyo (JP)

(73) Assignee: NIPPON TELEGRAPH AND TELEPHONE CORPORATION, Tokyo (JP)

(21) Appl. No.: 18/728,859

(22) PCT Filed: Jan. 18, 2023
(86) PCT No.: PCT/JP2023/001284

§ 371 Date: Jul. 12, 2024

(30) Foreign Application Priority Data
Jan. 21, 2022 (WO) PCT/JP2022/002206

(51) Int. Cl. G10K 11/178

(52) U.S. Cl. CPC G10K 11/17881; G10K 11/17857

(57) ABSTRACT

Provided is a noise control apparatus and the like capable of enhancing suppression performance as compared with a conventional noise control apparatus without enlarging or complicating each device in a case where noise control apparatuses are installed in respective areas such as seats in the same moving body such as a train or an airplane. The noise control apparatus performs active noise control. The noise control apparatus has suppression information that is related to noise suppression and is common to another noise control apparatus, which is disposed in the same moving body, corresponding to a reference microphone different from a reference microphone of the noise control apparatus, and suppresses noise using the common suppression information.

### TECHNICAL FIELD

The present invention relates to an active noise control (ANC) technique for suppressing external noise at a specific position.

### BACKGROUND ART

Non Patent Literature 1 is known as a conventional active noise control technique. In active noise suppression, a reference microphone, an error microphone, and a cancellation speaker are generally used. FIG. 1 illustrates a configuration example of a conventional noise control apparatus. A reference microphone 91 collects noise emitted from a noise source. A cancellation speaker 92 reproduces a cancellation signal generated by a suppression signal generation device 90, and emits a cancellation sound that cancels out the noise. Furthermore, an error microphone 93 collects and feeds back uncanceled noise. The suppression signal generation device 90 actively controls and generates a cancellation signal using a sound collection signal of the reference microphone 91 and a sound collection signal of the error microphone 93 so as to reduce the uncanceled noise. In order to emit sound capable of appropriately suppressing noise from the cancellation speaker 92, the suppression signal generation device 90 applies an adaptive filter to sound collected by the reference microphone 91 to generate a cancellation signal.

### CITATION LIST

### Non Patent Literature

Non Patent Literature 1: Kajikawa, “Active noise control no saikin no wadai to ouyou (in Japanese) (Recent topics and applications of active noise control)”, Technical Report from Special Interest Group on Music and Computer (MUS), vol. 2015-MUS-107, no. 3, pp. 1-6, May 2015.

### SUMMARY OF INVENTION

### Technical Problem

As the installation position of the reference microphone 91 gets closer to the noise source than a position where the noise is desired to be suppressed, that is, the installation position of the error microphone 93, a surplus time from when the noise arrives at the reference microphone 91 to when the noise arrives at the position where the noise is desired to be suppressed is generated, and therefore the suppression performance is improved more easily. Therefore, higher suppression performance can be achieved by arranging a plurality of reference microphones in a wider area. However, complication of wiring and enlargement of the device are problems.

An object of the present invention is to provide a noise control apparatus, a noise control system, a noise control method, and a program capable of enhancing suppression performance as compared with a conventional noise control apparatus without enlarging or complicating each device in a case where noise control apparatuses are installed in respective areas such as seats in the same moving body such as a train or an airplane.

### Solution to Problem

In order to solve the above problem, according to an aspect of the present invention, a noise control apparatus performs active noise control. The noise control apparatus has suppression information that is related to noise suppression and is common to another noise control apparatus, which is disposed in the same moving body, corresponding to a reference microphone different from a reference microphone of the noise control apparatus, and suppresses noise using the common suppression information.

In order to solve the above problem, according to another aspect of the present invention, a noise control system includes N noise control apparatuses configured to perform active noise control. The N noise control apparatuses respectively correspond to N reference microphones arranged in the same moving body. A noise control apparatus generates a cancellation signal for suppressing noise by using a sound collection signal of a corresponding reference microphone and a model. The noise control system includes a suppression information sharing unit configured to receive suppression information from a certain noise control apparatus and output, to another noise control apparatus, suppression information to be used by the another noise control apparatus in suppression information, and uses the suppression information of the certain noise control apparatus corresponding to a front area in the another noise control apparatus corresponding to a rear area with respect to the traveling direction of the moving body.

### Advantageous Effects of Invention

The present invention provides an effect that suppression performance can be enhanced as compared with a conventional noise control apparatus.

### BRIEF DESCRIPTION OF DRAWINGS

FIG. 1 is a diagram for explaining conventional active noise control.

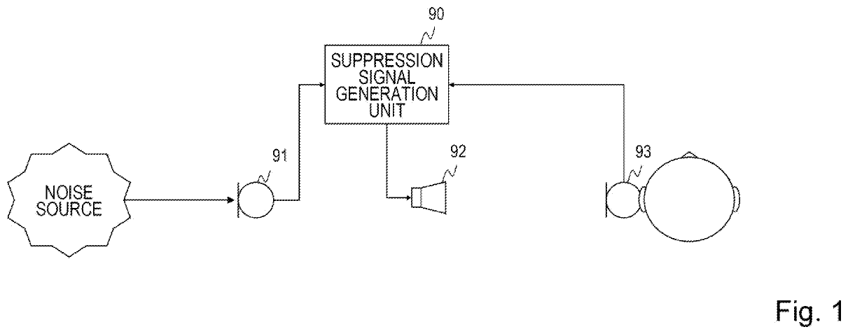

FIG. 2 is a functional block diagram of a noise control system according to a first embodiment.

FIG. 3 is a functional block diagram of a noise control apparatus according to the first embodiment.

FIG. 4 is a diagram illustrating an example of a processing flow of the noise control system according to the first embodiment.

FIG. 5 is a diagram for explaining a method of sharing suppression information.

FIG. 6 is a diagram for explaining a method of sharing suppression information.

FIG. 7 is a functional block diagram of a noise control system according to a second embodiment.

FIG. 8 is a diagram illustrating an example of a processing flow of a determination stage of the noise control system according to the second embodiment.

FIG. 9 is a diagram illustrating an example of a processing flow of a suppression stage of the noise control system according to the second embodiment.

FIG. 10 is a diagram for explaining a method of predicting a future sound collection signal of an area that is a suppression target.

FIG. 11 is a functional block diagram of a weight set determination unit.

FIG. 12 is a diagram for explaining correct answer data and explanation data.

FIG. 13 is a diagram for explaining processing by a weight set estimation unit.

FIG. 14 is a diagram illustrating a result of multiplying explanation data by an optimal weight at each time.

FIG. 15 is a diagram illustrating a configuration example of a computer to which the present technique is applied.

### DESCRIPTION OF EMBODIMENTS

Hereinafter, embodiments of the present invention will be described. Note that, in the drawings to be used for the following description, components having the same functions or steps for performing the same processing will be denoted by the same reference numerals, and redundant description will be omitted.

### Points of First Embodiment

In a case where noise control apparatuses are installed in respective areas such as seats in the same moving body such as a train or an airplane, a cancellation sound that is a signal for suppressing noise in a target area is generated using information of each noise control apparatus. With such a configuration, in a case where all places particularly have similar structures as in a train, an airplane, or the like, (i) a calculation result obtained in each noise control apparatus is transmitted from a noise control apparatus at the head in the traveling direction to a noise control apparatus at the rear in the traveling direction, or (ii) the calculation result is transmitted to the system that aggregates the information and shared, so that the suppression performance is enhanced.
A sound collection signal of a reference microphone of another noise control apparatus is used as a pseudo multi-channel reference microphone for generating a cancellation sound. With such a configuration, by using a sound collection signal of a reference microphone of a noise control apparatus close to the noise source for generation of the cancellation sound, the installation position of the reference microphone becomes closer to the noise source than a position where the noise is desired to be suppressed, and a surplus time is generated from when the noise arrives at the reference microphone to when the noise arrives at the position where the noise is desired to be suppressed, so that the suppression performance is easily improved.

### First Embodiment

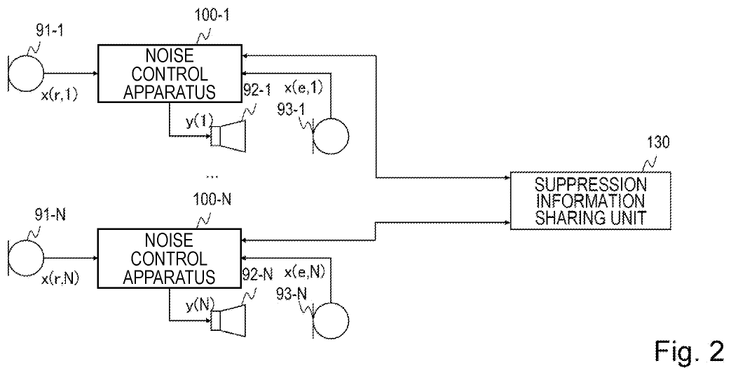

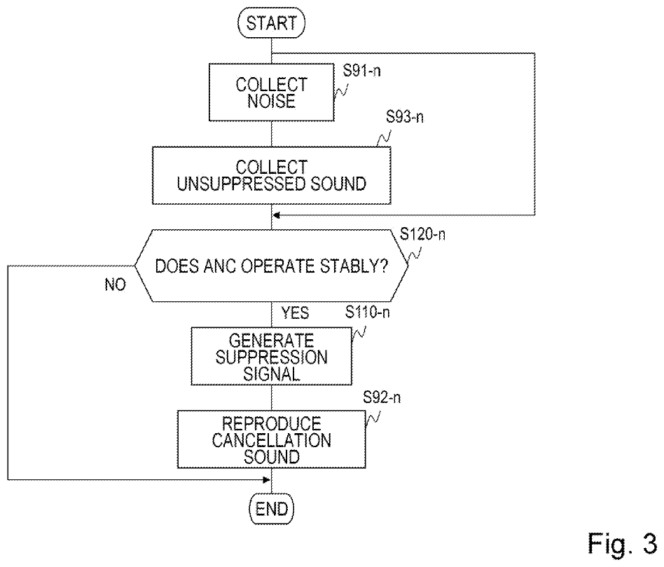

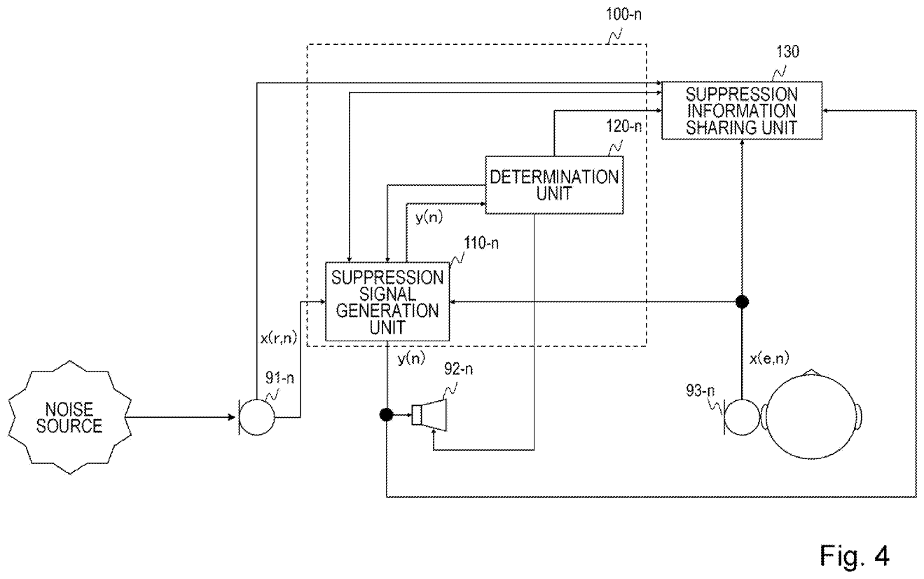

FIG. 2 is a functional block diagram of the noise control system according to the first embodiment, FIG. 3 illustrates a processing flow thereof, and FIG. 4 is a functional block diagram of the noise control apparatus according to the first embodiment.

The noise control system includes N reference microphones 91-n, N cancellation speakers 92-n, N error microphones 93-n, N noise control apparatuses 100-n, and a suppression information sharing unit 130. Here, it is assumed that n=1, 2, . . . , N is satisfied, and N is any integer of 2 or more. The N reference microphones 91-n, the N cancellation speakers 92-n, and the N error microphones 93-n are arranged in the same moving body.

An n-th noise control apparatus 100-n includes a suppression signal generation unit 110-n and a determination unit 120-n.

The n-th noise control apparatus 100-n receives an input of a sound collection signal x(r, n) of the n-th reference microphone 91-n and a sound collection signal x(e, n) of the n-th error microphone 93-n, has suppression information common to a noise control apparatus 100-n′ corresponding to a different reference microphone 91-n′, a different error microphone 93-n′, and a different cancellation speaker 92-n′ disposed in the same moving body, generates a cancellation signal (which will be hereinafter also referred to as a “suppression signal”) y(n) using the suppression information, and outputs the cancellation signal y(n) to the n-th cancellation speaker 92-n. Here, it is assumed that n′=1, 2, . . . , N, and n #n′ are satisfied. The n-th reference microphone 91-n, the error microphone 93-n, and the cancellation speaker 92-n are arranged at appropriate positions in the n-th area in order to realize noise suppression. The appropriate positions are, for example, positions at which microphones are arranged linearly at equal intervals at the same position of each seat in the same direction as the traveling direction in a case where the same moving body is a train.

The noise control apparatus is a special device configured such that a special program is read by a known or dedicated computer having, for example, a central processing unit (CPU), a main storage device (a random access memory (RAM)), and the like. The noise control apparatus executes each processing under the control of the central processing unit, for example. Data inputted to the noise control apparatus and data obtained by each processing are stored in, for example, the main storage device, and the data stored in the main storage device is read by the central processing unit as necessary and used for other processing. At least a part of each processing unit of the noise control apparatus may be configured by hardware such as an integrated circuit. Each storage unit included in the noise control apparatus can be configured with, for example, a main storage device such as a random access memory (RAM) or middleware such as a relational database or a key value store. However, each storage unit is not necessarily provided inside the noise control apparatus, and may be configured with an auxiliary storage device configured with a semiconductor memory element such as a hard disk, an optical disk, or a flash memory, and may be provided outside the noise control apparatus.

Hereinafter, each of the units will be described.

<Reference Microphone 91-n>

The reference microphone 91-n collects a sound to be suppressed (S91-n) and outputs a sound collection signal x(r, n). The sound to be suppressed collected by the reference microphone 91-n will be hereinafter referred to as a “noise”.

<Error Microphone 93-n>

The error microphone 93-n collects a sound that has not been suppressed by a reproduction sound reproduced from the cancellation speaker 92 including uncanceled noise (S93-n), and outputs a sound collection signal x(e, n).

At least one of the determination unit 120-n or the suppression signal generation unit 110-n below shares suppression information p(n) outputted from the suppression information sharing unit 130. Note that “to share” means that a certain noise control apparatus outputs suppression information to the suppression information sharing unit 130, the suppression information sharing unit 130 receives and stores the suppression information, another noise control apparatus receives the suppression information from the suppression information sharing unit 130, and the certain noise control apparatus and the another noise control apparatus store the same suppression information. Moreover, a state in which certain suppression information is shared means a state in which suppression information to be shared by a certain noise control apparatus and another noise control apparatus is stored in each of the noise control apparatuses. First, a process of not sharing suppression information p(n) will be described, and then a process of sharing suppression information p(n) will be described together with the processing by the suppression information sharing unit 130.

<Determination Unit 120-n>

The determination unit 120-n receives an input of a cancellation signal y(n) of the suppression signal generation unit 110-n to be described later, determines whether ANC operates stably or not using the cancellation signal y(n) (S120-n), and outputs a determination result j (n). For example, whether the ANC operates stably or not is determined on the basis of a magnitude relationship between a change amount per unit time of the cancellation signal y(n) and a predetermined threshold. For example, it is determined that the ANC does not operate stably in a case where the change amount of the power of the cancellation signal y(n) is larger than a predetermined threshold, while it is determined that the ANC operates stably in a case where the change amount is equal to or smaller than the predetermined threshold. The predetermined threshold may be calculated in advance by simulation or the like.

In a case where it is determined that the ANC does not operate stably (NO in S120-n), the determination unit 120-n outputs a control signal indicating that the ANC operation is not to be performed. Since it is only required to perform control so as not to perform the ANC operation, the suppression signal generation unit 110-n, the cancellation speaker 92-n, and the like to be described later are considered as output destinations of the control signal. (i) The determination unit 120-n may perform control so as not to perform the ANC operation by stopping reproduction of the cancellation signal y in the cancellation speaker 92-n. In this case, the control signal may be outputted to the cancellation speaker 92-n to stop reproduction of the cancellation signal y(n), or the control signal may be outputted to the suppression signal generation unit 110-n to stop generation or output of the cancellation signal y(n) in the suppression signal generation unit 110-n. (ii) The determination unit 120-n may output the control signal to the suppression signal generation unit 110-n to stop the update of the adaptive filter so that the ANC operation is not performed. The processes (i) and (ii) may be switched according to the situation. However, by adopting (i) to maintain the update of the adaptive filter, it is possible to prevent the operation at the time of restarting the ANC operation from becoming unstable. The time during which the ANC operation is not performed may be a time required until the ANC operation is stabilized.

In a case where it is determined that the ANC operates stably (YES in S120-n), the determination unit 120-n outputs a control signal indicating that the ANC operation is to be performed. However, when the control signal indicating that the ANC operation is not to be performed is not received in each unit, the ANC operation may be basically performed, and the determination unit 120-n may not output the control signal indicating that the ANC operation is to be performed. In this case, when it is determined that the ANC operates stably (YES in S120-n), the determination unit 120-n does not perform any processing, and shifts the processing to the suppression signal generation unit 110-n.

<Suppression Signal Generation Unit 110-n>

The suppression signal generation unit 110-n receives inputs of a sound collection signal x(r, n) and a sound collection signal x(e, n), generates a cancellation signal y(n) for suppressing noise by using the sound collection signal x(r, n) and the model (S110-n), and outputs the cancellation signal y(n). Moreover, the suppression signal generation unit 110 updates the model using the sound collection signals x(r, n) and x(e, n). For example, the model is an adaptive filter, and the filter coefficient thereof is updated. Note that the model is not limited to the filter coefficient, and may be another model or a model generated using a technique such as deep learning.

A conventional technique can be used as a method of generating the cancellation signal. For example, the method in Non Patent Literature 1 can be used. In the present embodiment, the feedforward ANC is realized by the sound collection signal x(r, n), the sound collection signal x(e, n), and the cancellation signal y(n). An interference sound formed by noise from the noise source and the reproduction sound of the cancellation signal y is detected by the error microphone 93-n, the noise from the noise source is detected by the reference microphone 91-n, the cancellation signal y(n) is generated by inputting the sound collection signal x(r, n) of the reference microphone 91-n to the adaptive filter implemented by a digital filter, and the cancellation signal y(n) is reproduced by the cancellation speaker 92-n. The reproduction sound of the cancellation signal y(n) propagates through a secondary path that is a series of transmission systems from the cancellation speaker 92-n to the error microphone 93-n. Then, using the sound collection signal x(r, n) of the reference microphone 91-n and the sound collection signal x(e, n) of the error microphone 93-n, the filter coefficient of the adaptive filter is updated by the adaptive algorithm such that the input of the error microphone 93-n is minimized. Since a conventional update method can be used as a method of updating the filter coefficient of the adaptive filter, description thereof will be omitted. In the feedforward ANC, a secondary path model in which a secondary path is estimated is used to compensate for the influence of the secondary path in an adaptive algorithm.

<Cancellation Speaker 92-n>

The cancellation speaker 92-n receives an input of the cancel signal y(n), and reproduces the cancellation signal y(n) (S92-n). In a case where the reproduction sound reproduced from the cancellation speaker 92 and the noise to be suppressed have completely opposite phases, waves cancel each other out when the reproduction sound and the noise to be suppressed overlap each other, that is, when the sound waves overlap each other, and therefore the noise is suppressed. As described above, the error microphone 93-n collects sound that has not been suppressed by the reproduction sound reproduced from the cancellation speaker 92-n.

### <Suppression Information Sharing Unit 130>

The suppression information sharing unit 130 receives and stores the suppression information from N noise control apparatuses 100-n. Furthermore, the suppression information sharing unit 130 outputs, to each noise control apparatus 100-n, suppression information to be used in each noise control apparatus 100-n in the suppression information. Hereinafter, the suppression information to be outputted to the n-th noise control apparatus 100-n is denoted by p(n).

The suppression information is information related to noise suppression, and is, for example, the sound collection signals x(r, n) and x(e, n), the cancellation signal y(n), the determination result j (n), and a model used in the suppression signal generation unit 110-n. These pieces of suppression information are shared by the N noise control apparatuses 100-n.

(1) In a case where a multi-channel reference microphone is used for generating a cancellation sound in a pseudo manner:

The suppression information sharing unit 130 receives N sound collection signals x(r, n) and outputs N−1 sound collection signals x(r, n′) to the n-th suppression signal generation unit 110-n. The n-th suppression signal generation unit 110-n generates and outputs a cancellation signal y(n) for suppressing noise by using N−1 sound collection signals x(r, n′) and sound collection signals x(r, n), and a model. In this case, the model receives inputs of N sound collection signals x(r, n), and outputs a cancellation signal y(n).

(2) In a case where suppression information of a noise control apparatus corresponding to a front area is shared and used by a noise control apparatus corresponding to a rear area:

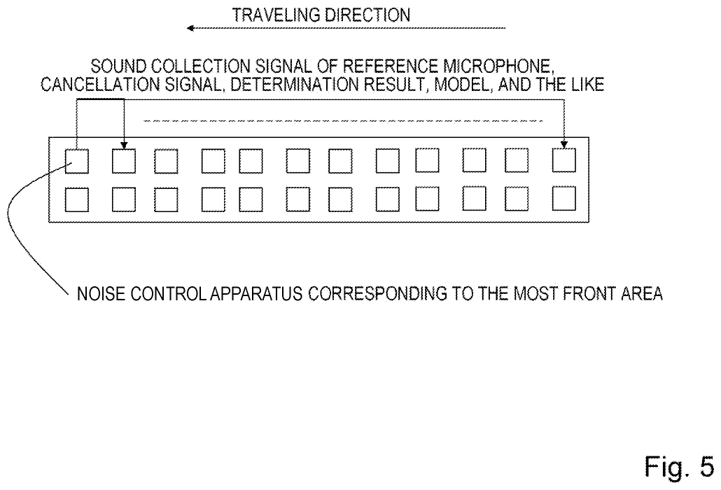

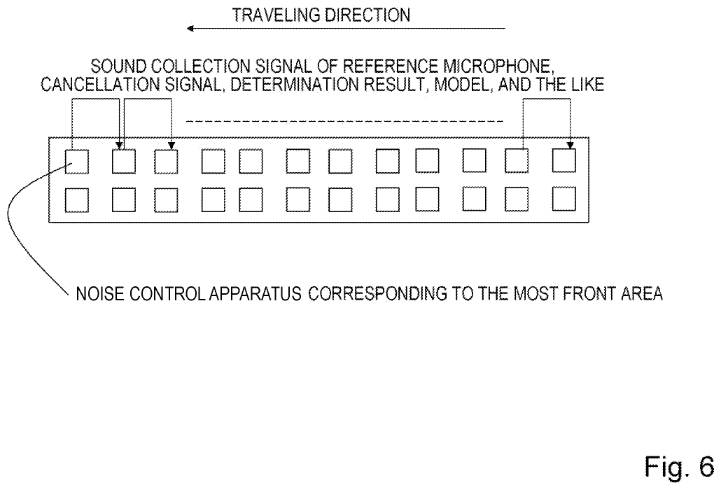

The suppression information sharing unit 130 may receive suppression information (e.g., the sound collection signal of the reference microphone located in a front area with respect to the traveling direction of the moving body, the sound collection signal of the error microphone, the cancellation signal inputted to the cancellation speaker, the determination result of the determination unit of the noise control apparatus corresponding to the front area, and the model of the suppression signal generation unit of the noise control apparatus corresponding to the front area) of the noise control apparatus corresponding to the front area, and output the suppression information to the noise control apparatus corresponding to the rear area. As illustrated in FIG. 5, the suppression information outputted from the noise control apparatus corresponding to the most front area may be outputted to noise control apparatuses corresponding to the other rear areas at once. Alternatively, as illustrated in FIG. 6, the suppression information outputted from the noise control apparatus corresponding to a front area may be outputted to the noise control apparatus corresponding to an area right behind the noise control apparatus and may be sequentially transmitted. In particular, by using the suppression information outputted from the noise control apparatus corresponding to the most front area in the noise control apparatus corresponding to the rear area, it becomes easy to create a surplus time in the rear area. In a moving body such as a train, since a fixed vehicle travels on a fixed travel route, noise characteristics are similar between vehicles, it is easy to predict a noise suppression environment, and a processing result of a noise control apparatus corresponding to a front area can be shared and used by a noise control apparatus corresponding to a rear area. Note that, in the case of including one or more moving bodies (vehicles and the like) as in a train, since a vehicle at the front and a vehicle at the rear have similar structures, the area in a vehicle at the front may be set as a front area, and the area in a vehicle at the rear may be set as a rear area. Moreover, since noise characteristics are similar in one vehicle, a front seat in one vehicle may be set as the front area, and a rear seat in the same vehicle may be set as a rear area.

For example, it is used as follows.

(i) For example, the cancellation signal y(n) may be generated using the sound collection signal of the reference microphone located in the front in the noise control apparatus corresponding to the reference microphone located at the rear, or the cancellation signal y(n) may be used for updating the model.

(ii) The cancellation signal inputted to the determination unit of the noise control apparatus corresponding to the front area may be received by the determination unit of the noise control apparatus corresponding to a rear area as an input and may be used to determine whether the ANC operates stably or not.

(iii) The determination result of the determination unit of a noise control apparatus corresponding to the front area may be used as the determination result of the determination unit of a noise control apparatus corresponding to the rear area. In this case, the determination unit of the noise control apparatus corresponding to the rear area can omit the determination processing.

(iv) In a case where respective places have similar structures as in a train or an airplane, a model updated by a suppression signal generation unit of a noise control apparatus corresponding to a front area may be used as a model of a suppression signal generation unit of a noise control apparatus corresponding to a rear area. When active noise control is performed at a plurality of positions having similar noise characteristics as in train seats, a stable operation can be realized by using a calculation result of ANC in one seat also for other seats. In particular, since the noise characteristics in a rear area follow the noise characteristics in a front area, sharing the model obtained by the noise control apparatus corresponding to the front area with the noise control apparatus corresponding to the rear area creates a surplus time, and the suppression performance can be improved. In this case, the update processing of the model of the suppression signal generation unit of the noise control apparatus corresponding to the rear area can be omitted.

### Effects

With the above configuration, the suppression performance can be enhanced as compared with a conventional noise control apparatus. It is possible to increase the accuracy and processing speed of ANC by sharing a sound collection signal obtained from a large number of microphones (reference microphones and error microphones) dispersedly arranged in the same moving body, a cancellation signal and a determination result obtained using the sound collection signal, and a model with another noise control apparatus. For a noise situation that varies depending on the location, the ANC system can be operated safely, and a convergence speed of signal calculation in the suppression signal generation unit can be improved.

### Variation

Although the present embodiment has explained a configuration that the N noise control apparatuses 100-n share the suppression information, only some of the N noise control apparatuses 100-n may share the suppression information.

### Second Embodiment

Differences from the first embodiment will be mainly described.

In the present embodiment, a sound selection signal x(r, n) (signal to be suppressed) to be collected in the future by the reference microphone 91-n is predicted from N−1 sound collection signals x(r, n′) respectively collected by N−1 reference microphones 91-n′, in order to generate a cancellation signal that cancels out the noise. By using the predicted value of the sound collection signal x(r, n) to be collected in the future, it is possible to cope with deterioration in suppression performance due to a delay generated in the process.

A state-space model that performs linear prediction for a stationary signal in time-series analysis for predicting a general time-series signal has been studied for a long time (see Reference Literature 1).

(Reference Literature 1) Kalman, R. E., “A new approach to linear filtering and prediction problems”, Trans. ASME-J, Basic Eng. (ser. D), 82, pp. 35-45, 1960.

Moreover, in Reference Literature 2, in order to improve noise suppression performance in an earphone, microphones are installed on an outer side and an inner side of the earphone, so that a function of predicting and suppressing noise in a surrounding environment is realized using a predictor configured by a deep neural network (DNN).

(Reference Literature 2) Jang, Young-Jae, Jaehyun Park, Won-Cheol Lee, and Hong-June Park., “A Convolution-Neural-Network Feedforward Active-Noise-Cancellation System on FPGA for In-Ear Headphone”, Applied Sciences 12, no. 11:5300, 2022.

First, noise is often a nonstationary sound for the following reasons.
The position of the noise source may change from moment to moment.
Noise itself may be generated from a wide variety of sources, and tends to be nonstationary.

Therefore, in Reference Literature 1, since a state-space model that performs linear prediction for a stationary signal is used, it is difficult to perform prediction by simply applying average, dispersion, and covariance to nonstationary noise.

Moreover, in a case where the DNN of Reference Literature 2 is applied to multi channels, a calculation amount increases, and thus a calculation load becomes heavy, and it is difficult to perform calculation simultaneously with a plurality of microphones.

The present embodiment solves such problems.

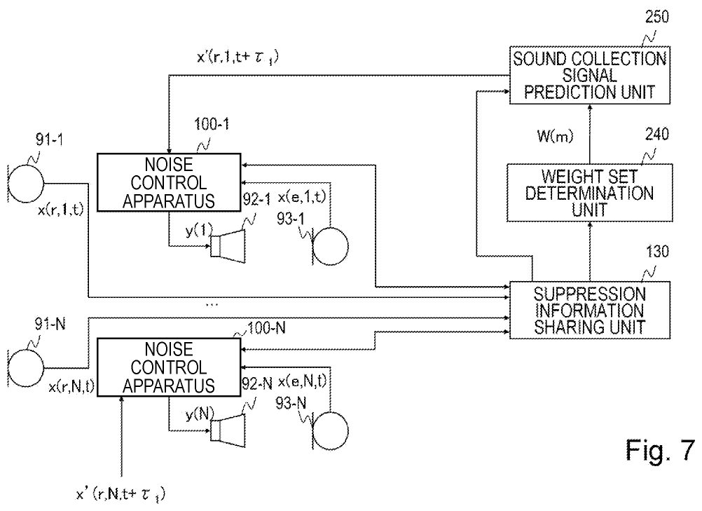

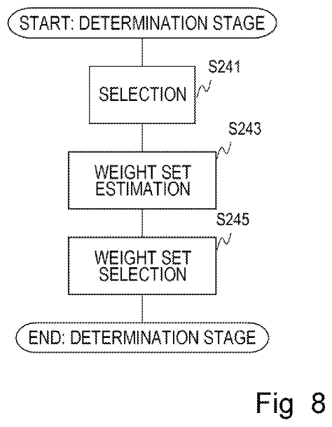

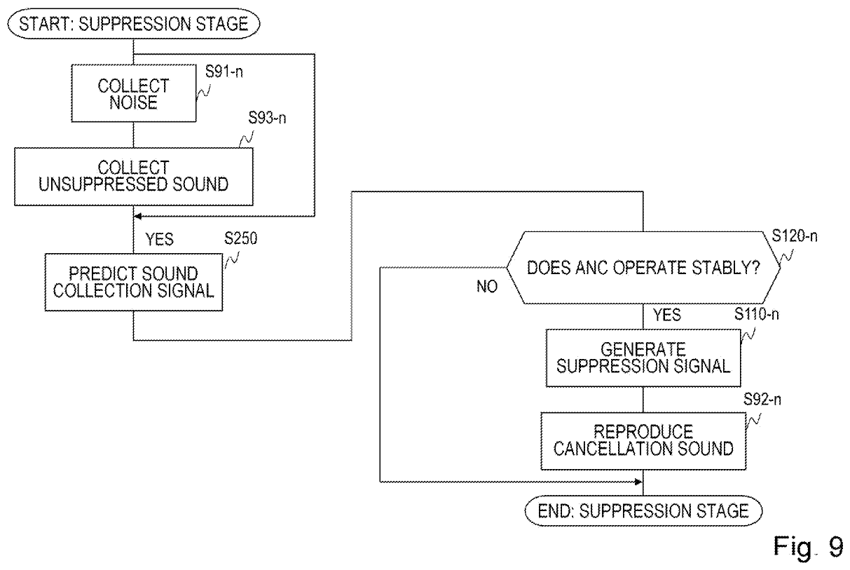

FIG. 7 is a functional block diagram of a noise control system according to a second embodiment, FIG. 8 illustrates a processing flow of a determination stage of the noise control system, and FIG. 9 illustrates a processing flow of a suppression stage of the noise control system.

The noise control system includes N reference microphones 91-n, N cancellation speakers 92-n, N error microphones 93-n, N noise control apparatuses 100-n, a suppression information sharing unit 130, a weight set determination unit 240, and a sound collection signal prediction unit 250.

The reference microphone 91-n outputs a sound collection signal x(r, n, t) to, not the noise control apparatus 100-n, but the suppression information sharing unit 130. Here, t is an index indicating a sample time.

The n-th noise control apparatus 100-n receives an input of, not the sound collection signal x(r, n, t), but the predicted value x′(r, n, t+τ₁) of the sound collection signal x(r, n, t+τ₁) that is ti samples after the reference microphone 91-n.

The processing by the noise control system consists of a determination stage and a suppression stage.

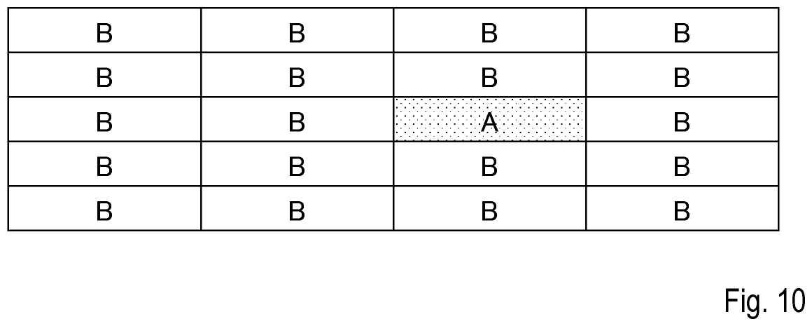

When the sound field is regarded as a linear system, a sound field around an area A that is a suppression target in FIG. 10 can be expressed by simple superposition of sounds existing around the area A. There is always a sound that is first collected in an area B, other than sounds that are first generated and collected in the area A. It is assumed that a sound first generated and collected in the area A is likely to be emitted by a person using the area A and is an important sound (not to be suppressed) for a person using the area A. It is sufficient to estimate a sound to be suppressed from sounds collected in the area B group. Therefore, in the present embodiment, a future sound collection signal in an area that is a suppression target is predicted by superimposing current or past sound collection signals collected in areas that are not the suppression target.

In the suppression stage of the present embodiment, a sound collection signal to be suppressed that is to be observed in the future is predicted from sound collection signals other than the sound collection signal x to be suppressed.

In the determination stage, a weight to be used for predicting a sound collection signal to be suppressed that is to be observed in the future is determined. Since a combination of optimal weights at each time and further a combination of optimal weights in the entire time zone can be considered, L1 regularization (LASSO) is used for optimization at each time, and a greedy method is used for optimization in the entire time zone, for example.

First, the determination stage will be described.

### <Determination Stage>

In the determination stage, a nonstationary noise is first collected by N reference microphones 91-n, and a sound collection signal x(r, n, t) is stored in the suppression information sharing unit 130.

### <Weight Set Determination Unit 240>

The weight set determination unit 240 extracts N sound collection signals x(r, n, t) from the sound collection signal x(r, n, t+S) at time t+S to the sound collection signal x(r, n, t−τ₁−τ₂) at time t−τ₁−τ₂ from the suppression information sharing unit 130. Note that S is a time width used for prediction. The τ₁ is a parameter indicating a time difference between the current time and a time desired to be predicted, and τ₂ is a parameter indicating a time width to be retraced for prediction.

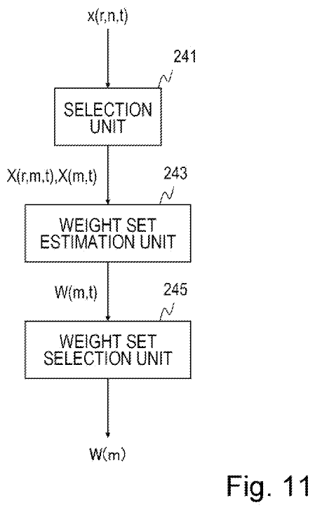

FIG. 11 illustrates a functional block diagram of the weight set determination unit 240. The weight set determination unit 240 includes a selection unit 241, a weight set estimation unit 243, and a weight set selection unit 245.

### <Selection Unit 241>

The selection unit 241 receives inputs of N sound collection signals x(r, n, t) from a sound collection signal x(r, n, t+S) at time t+S to a sound collection signal x(r, n, t−τ₁−τ₂) at time t−τ₁−τ₂, selects the sound collection signal x(r, m, t) to be suppressed (S241), sets S+1 sound collection signals x(r, m, t), x(r, m, t+1), . . . , and x(r, m, t+S) from time t to time t+S among selected sound collection signals as correct answer data X(r, m, t)=[x(r, m, t), x(r, m, t+1), . . . , x(r, m, t+S)]^{T}∈R^{(S+1)×1}, and sets (τ₂+S+1)×(N−1) sound collection signals x(r, m′, t−τ₁−τ₂), x(r, m′, τ₁−τ₂+1), . . . x(r, m′, t−τ₁+S) from time t−τ₁−τ₂ to time t−τ₁+S among unselected sound collection signals as explanation data. Note that the explanation data means data used for estimation of the correct answer data X(r, m, t). The m is any one of 1, 2, . . . , and N and is an index indicating a selected sound collection signal, m′ is an index indicating a sound collection signal other than the selected sound selection signal, m′=1, 2, . . . , N is satisfied, and m≠m′ is satisfied.

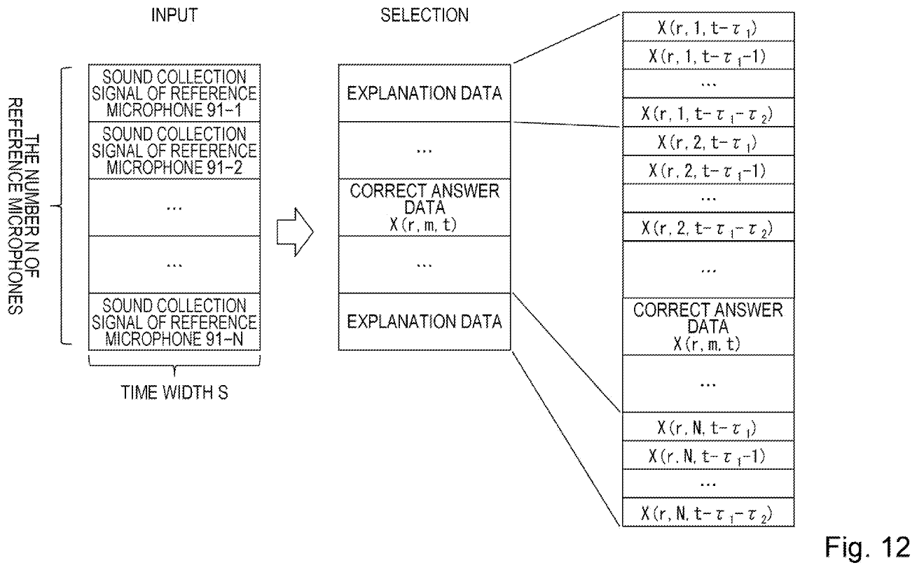

In order to consider the influence of the signal observation delay due to physical distances between the reference microphone 91-m corresponding to the sound collection signal x(r, m, t) to be suppressed and the other N−1 reference microphones 91-m′, sound pickup signals obtained by shifting a sound collection signal obtained by one reference microphone with multiples of a certain time are combined in the channel direction. FIG. 12 is a diagram for explaining correct answer data and explanation data. For example, sound collection signals x(r, m′, t−τ₁−τ₂), x(r, m′, τ₁−τ₂+1), . . . , and x(r, m′, t−τ₁+S) of a certain reference microphone 91-m′ are set as one set for each time width S, and τ₂+1 sets are created by shifting with multiples of a certain time as follows.

X(r,m′,t−τ₁)=[x(r,m′,t−τ₁),x(r,m′,t−τ₁+1), . . . ,x(r,m′,t−τ₁+S)]∈R^{(S+1)×1},

X(r,m′,t−τ₁−1)=[x(r,m′,t−τ₁−1),x(r,m′,t−τ₁+0), . . . ,x(r,m′,t−τ₁−1+S)]∈R^{(S+1)×1}, . . .

X(r,m′,t−τ₁−τ₂)=[x(r,m′,t−τ₁−τ₂),x(r,m′,t−τ₁−τ₂+1), . . . ,x(r,m′,t−τ₁−τ₂+S)]∈^{R(S+1)×1}

Furthermore, integration is performed in the channel direction, and the following matrix X(m, t)∈R^{(S+1)×(N-1)τ_2} is generated as the explanation data. Here, the superscript τ_2 means τ₂.

$$X ( m , t ) = [ \begin{matrix}X ( r , 1 , t − {τ}_{1} ) \\ X ( r , 1 , t - {τ}_{1} − 1 ) \\ ⋮ \\ X ( r , 1 , t − {τ}_{1} − {τ}_{2} ) \\ X ( r , 2 , t − {τ}_{1} ) \\ X ( r , 2 , t − {τ}_{1} − 1 ) \\ ⋮ \\ X ( r , N , t − {τ}_{1} − {τ}_{2} + 1 ) \\ X ( r , N , t − {τ}_{1} − {τ}_{2} )\end{matrix} ] \qquad [ Math . 1 ]$$

The selection unit 241 outputs correct answer data X(r, m, t)∈R^{(S+1)×1} and explanation data X(m, t)∈^{R(s+1)×(N-1)τ_2}.

The selection unit 241 may manually select a sound collection signal specified by some input means (mouse, keyboard, etc.) as the sound collection signal to be suppressed, or may automatically select a sound collection signal to be suppressed randomly or according to a predetermined rule. Moreover, the selection unit 241 may sequentially select N sound collection signals as the sound collection signals to be suppressed, or may sequentially select only some of the N sound collection signals as the sound collection signals to be suppressed.

### <Weight Set Estimation Unit 243>

The weight set estimation unit 243 receives inputs of the correct answer data X(r, m, t)∈R^{(S+1)×1} and the explanation data X(m, t)∈R^{(S+1)×(N-1)τ_2}, estimates an optimal weight W(m, t)=[W(m, t, 1), W(m, t, 2), . . . , W(m, t, (N−1)τ₂)]^{T}∈R^{((N-1)τ_2)×1} to be used for estimating the correct answer data X (r, m, t) from the explanation data X(m, t) (S243), and outputs the estimated weight W(m, t).

In the present embodiment, the optimal weight W(m, t) is estimated by the least squares method on the assumption that the correct answer data X(r, m, t) is obtained by regression of the explanation data X(m, t).

The loss function is L=|X(r, m, t)−X(m, t)^{T}W(m, t)|²+Q, Q is a normalization term, and the normalization term Q is Q=α|W(m, t)| or Q=α|W (m, t)|², where a is an update constant.

The weight set estimation unit 243 optimizes the weight at each time by, for example, L1 regularization (LASSO). A time (t−T to t) desired to be predicted at the time of suppression is fixed, and a loss function L=|X(r, m, t)−X(m, t)^{T}W(m, t)|²+Q is calculated using explanation data X(m, t)∈R^{(S+1)×(N-1)τ_2}, where t(P)< . . . <t(3)<t(2)<t(1)<t is satisfied. For the minimization problem of the loss function L, Akaike's Information Criterion (AIC) or Bayesian Information Criterion (BIC), for example, can be used as an index of model applicability.

For example, when the correct answer data X(r, m, t(p)) at the time t(p) is predicted, explanation data

$$X ( m , t ) = [ \begin{matrix}X ( r , 1 , t − {τ}_{1} ) \\ X ( r , 1 , t - {τ}_{1} − 1 ) \\ ⋮ \\ X ( r , 1 , t − {τ}_{1} − {τ}_{2} ) \\ X ( r , 2 , t − {τ}_{1} ) \\ X ( r , 2 , t − {τ}_{1} − 1 ) \\ ⋮ \\ X ( r , N , t − {τ}_{1} − {τ}_{2} + 1 ) \\ X ( r , N , t − {τ}_{1} − {τ}_{2} )\end{matrix} ] \qquad [ Math . 2 ]$$

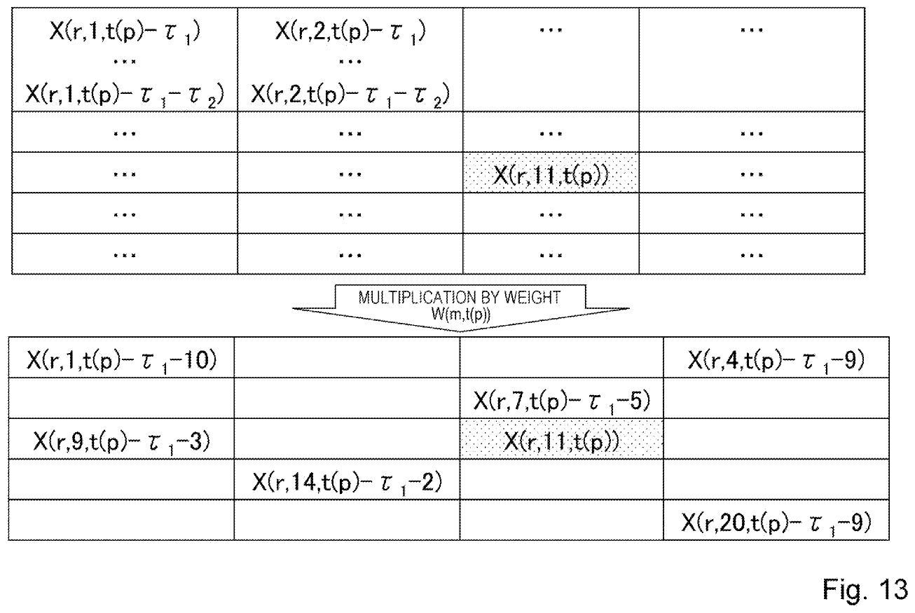

is multiplied by a weight W(m, t(p)) as illustrated in FIG. 13 to extract a sound collection signal to be emphasized in prediction. Note that, in FIG. 13, X(r, 11, t(p)) is set as correct answer data. Note that, in FIG. 13, a blank cell indicates that no value remains as a result of multiplication by a weight.

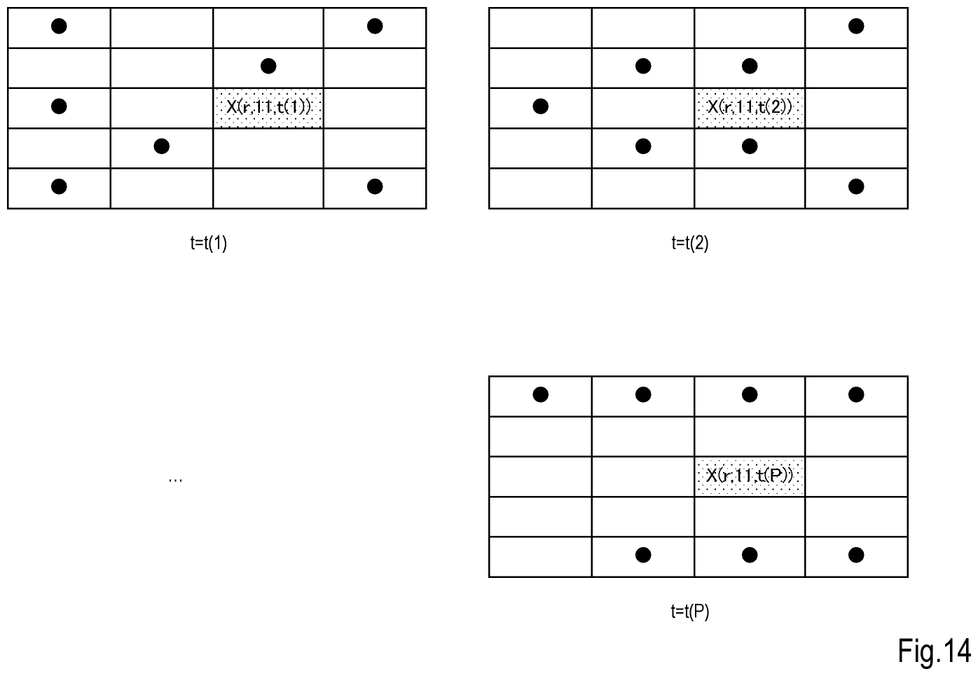

The weight set estimation unit 243 changes the time t P times, and estimates and outputs optimal weights W(m, t(1)), . . . , and W(m, t(P)) respectively at P times t(1), . . . , and t(P). P is any integer of 2 or more. FIG. 14 illustrates a result of multiplying the explanation data by the optimal weights W(m, t(1)), . . . , and W(m, t(P)) at respective times, in which a black circle cell indicates that a value remains as a result of multiplying the weight, while a blank cell indicates that no value remains as a result of multiplying the weight.

### <Weight Set Selection Unit 245>

The weight set selection unit 245 receives inputs of P optimal weights W(m, t(p)), applies the weights W(m, t(1)), W(m, t(2)), . . . , and W(m, t(P)) obtained at the respective times t(1), t(2), . . . , and t(P) to other times, selects a weight with the smallest loss function L as the final optimal weight W(m) (S245), and outputs the weight W(m) to the sound collection signal prediction unit 250. For example, a greedy method is used to obtain an optimal weight set in the entire time zone. For example, a weight W(m, t(u)) obtained at a certain time t(u) is applied to explanation data X(m, t(p)) at each time t(p), P loss functions L(t(p), W(m, t(u)) are obtained, and a sum thereof is obtained. Similar processing is performed for u=1, 2, . . . , P, and a weight with the smallest sum is set as the final optimal weight.

The above processing is performed before shifting to the suppression stage.

### <Suppression Stage>

### <Sound Collection Signal Prediction Unit 250>

The sound collection signal prediction unit 250 receives the optimal weight W (m) prior to the suppression processing.

The sound collection signal prediction unit 250 extracts N−1 sound collection signals x(r, m′, t) other than the sound collection signal to be suppressed from the sound collection signal x(r, m′, t) at the time t to the sound collection signal x(r, m′, t−τ₂) at the time t-12 from the suppression information sharing unit 130.

Using X(m, t) and W(m), the sound collection signal prediction unit 250 obtains a predicted value X′(r, m, t+ τ₁)=[x′(r, m, t−S+τ₁), x′(r, m, t−S+1+τ₁), . . . , x′(r, m, t+τ₁)]^{T}=X(m, t)^{T}W(m)∈R^{(S+1)×1} of the sound collection signal to be suppressed τ₁ samples after (S 250), and outputs the predicted value to the noise control apparatus 100-m corresponding to the sound collection signal to be suppressed. Note that

$$X ( m , t ) = [ \begin{matrix}X ( r , 1 , t ) \\ X ( r , 1 , t - 1 ) \\ ⋮ \\ X ( r , 1 , t − {τ}_{2} ) \\ X ( r , 2 , t ) \\ X ( r , 2 , t − 1 ) \\ ⋮ \\ X ( r , N , t − {τ}_{2} + 1 ) \\ X ( r , N , t − {τ}_{2} )\end{matrix} ] \qquad [ Math . 3 ]$$

is satisfied, and X(r, m′, t)=[x(r, m′, t−S), x(r, m′, t−S+1), . . . , x(r, m′, t)]∈R^{(S+1)×1} is satisfied.

The processing by the noise control apparatus 100-m in the suppression stage is similar to that of the first embodiment except that the processing is performed using the predicted value x′(x (r, m, t+τ₁) of the sound collection signal instead of the sound collection signal x(r, m).

<Suppression Signal Generation Unit 110-n>

The suppression signal generation unit 110-n receives inputs of the predicted value x′(r, n, t+τ₁) of the sound collection signal and the sound collection signal x(e, n, t), generates a cancellation signal y(n, t) for suppressing noise by using the predicted value x′(r, n, t+ τ₁) and the model (S110-n), and outputs the cancellation signal y(n, t). Moreover, the suppression signal generation unit 110 updates the model using the prediction value x′(r, n, t+τ₁) and the sound collection signal x(e, n, t).

### Effects

With the above configuration, since the difference between a time when the sound is collected in the future and a time when the noise actually arrives at the position where the noise is desired to be suppressed becomes large, the surplus time is increased, and the suppression performance can be enhanced as compared with a conventional noise control apparatus.

### Other Variations

The present invention is not limited to the above embodiments and variations. For example, various kinds of processing described above may be executed not only in time series in accordance with the description but also in parallel or individually in accordance with processing abilities of the devices that execute the processing or as necessary. In addition, modifications can be made as needed within the gist of the present invention.

### <Program and Recording Medium>

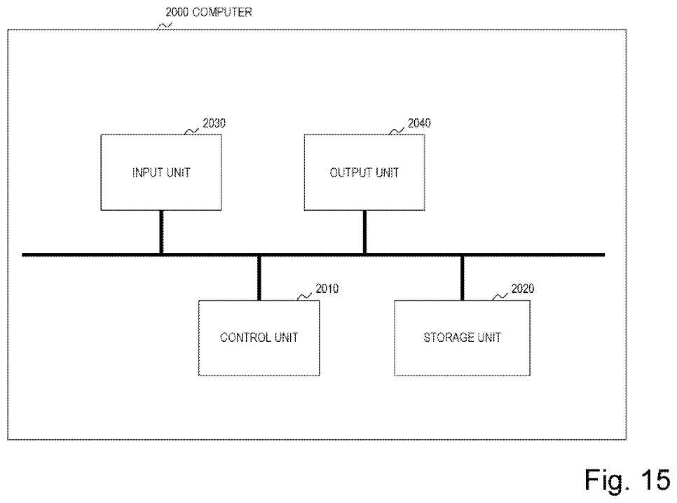

Various kinds of processing described above can be carried out by causing a storage unit 2020 of a computer illustrated in FIG. 15 to load a program for executing each step of the method described above and causing a control unit 2010, an input unit 2030, an output unit 2040, and the like to operate.

The program in which the processing content is written may be recorded on a computer-readable recording medium. The computer-readable recording medium may be, for example, any recording medium such as a magnetic recording device, an optical disk, a magneto-optical recording medium, or a semiconductor memory.

Moreover, the program is distributed by, for example, selling, transferring, or renting a portable recording medium such as a DVD or a CD-ROM on which the program is recorded. Furthermore, the program may be stored in a storage device of a server computer, and the program may be distributed by transferring the program from the server computer to another computer via a network.

For example, a computer for executing such a program first temporarily stores a program recorded on a portable recording medium or a program transferred from a server computer in a storage device of the computer. Then, when executing processing, the computer reads the program stored in the recording medium of the computer and executes the processing according to the read program. Moreover, as another mode of the program, the computer may read the program directly from a portable recording medium and execute processing according to the program, or alternatively, the computer may sequentially execute processing according to a received program every time the program is transferred from a server computer to the computer. Moreover, the above-described processing may be executed by a so-called application service provider (ASP) type service that implements a processing function only by an execution instruction and result acquisition without transferring the program from a server computer to the computer. Note that the program in this mode includes information that is to be used in processing by an electronic computer and is equivalent to the program (data and the like that are not direct commands to the computer but have properties that define the processing to be performed by the computer).

Moreover, although the present devices are each configured by executing a predetermined program on a computer in this mode, at least a part of the processing content may be implemented by hardware.

1. A noise control apparatus for performing active noise control,
wherein the noise control apparatus has suppression information that is information related to noise suppression and is common to another noise control apparatus that is disposed in a same moving body and corresponds to a reference microphone different from a reference microphone of the noise control apparatus, and suppresses noise using the common suppression information.

2. The noise control apparatus according to claim 1,
wherein the noise control apparatus uses suppression information of another noise control apparatus corresponding to a more front area than an area corresponding to the noise control apparatus with respect to a traveling direction of the moving body.

3. A noise control system comprising N noise control apparatuses configured to perform active noise control,
wherein the N noise control apparatuses respectively correspond to N reference microphones arranged in a same moving body,
the noise control apparatus generates a cancellation signal for suppressing noise by using a sound collection signal of a corresponding reference microphone and a model,
the noise control system further comprises a suppression information sharing unit configured to receive suppression information from a certain noise control apparatus and output, to another noise control apparatus, suppression information to be used in the another noise control apparatus in the suppression information, and
the another noise control apparatus corresponding to a rear area uses the suppression information of the certain noise control apparatus corresponding to a front area with respect to a traveling direction of the moving body.

4. The noise control system according to claim 3,
wherein the noise control apparatus includes processing circuitry configured to execute a determination processing in which the processing circuitry unit determines whether active noise control operates stably or not by using a cancellation signal reproduced by a cancellation speaker, and
the suppression information includes at least one of:
(i) a sound collection signal of a reference microphone;
(ii) a cancellation signal reproduced by the cancellation speaker;
(iii) a result of determination by the determination processing; or
(iv) a model used for generating a cancellation signal from a sound collection signal of a reference microphone.

5. A noise control method that uses a noise control apparatus configured to perform active noise control,
wherein the noise control apparatus has suppression information that is information related to noise suppression and is common to a noise control apparatus that is disposed in a same moving body and corresponds to a reference microphone different from a reference microphone of the noise control apparatus, and suppressing noise using the common suppression information.

6. The noise control method according to claim 5,
wherein the noise control method uses a noise control system including N noise control apparatuses configured to perform active noise control,
the N noise control apparatuses respectively correspond to N reference microphones arranged in a same moving body,
the noise control apparatus generates a cancellation signal for suppressing noise by using a sound collection signal of a corresponding reference microphone and a model,
the noise control system further includes a suppression information sharing unit configured to receive suppression information from a certain noise control apparatus and output, to another noise control apparatus, suppression information to be used in the another noise control apparatus in the suppression information, and
the another noise control apparatus corresponding to a rear area uses the suppression information of the certain noise control apparatus corresponding to a front area with respect to a traveling direction of the moving body.

7. The noise control apparatus according to claim 1,
wherein the noise control apparatus predicts a sound collection signal to be collected in future by a reference microphone of the noise control apparatus by using a sound collection signal collected by a reference microphone different from the reference microphone of the noise control apparatus, and generates a cancellation signal for suppressing noise by using the predicted sound collection signal.

8. The noise control method according to claim 5, further comprising:
predicting a sound collection signal to be collected in future by a reference microphone of the noise control apparatus used in the noise control method by using a sound collection signal collected by a reference microphone different from the reference microphone of the noise control apparatus used in the noise control method; and generating a cancellation signal for suppressing noise by using the predicted sound collection signal.

9. A non-transitory computer-readable recording medium having recorded thereon a program for causing a computer to function as the noise control apparatus according to claim 1.
